(19) United States
(12) Patent Application Publication
(10) Pub. No.: US 2020/0136180 A1
(43) Pub. Date: Apr. 30, 2020

(54) COMPOSITE FILM, PRODUCTION THEREOF, AND USE THEREOF IN A SOLID-STATE ELECTROCHEMICAL CELL

(71) Applicant: Robert Bosch GmbH, Stuttgart (DE)

(72) Inventors: Hyunchul Roh, Putzbrunn (DE); Alexander Reitzle, Neu-Ulm (DE); Joo Young Choi, Ludwigsburg (DE); Tobias Bach, Karlsruhe (DE)

(21) Appl. No.: 16/668,032

(22) Filed: Oct. 30, 2019

(30) Foreign Application Priority Data
Oct. 30, 2018 (DE) 102018218556.5

(51) Int. Cl. H01M 10/0562; H01M 2/14; H01M 2/16; H01M 10/0525

(52) U.S. Cl. CPC H01M 10/0562; H01M 10/0525; H01M 2/1653; H01M 2/145

(57) ABSTRACT

A composite film (1) comprising a composition comprising at least one solid electrolyte and at least one binder, wherein the fraction of binder in the composition increases with decreasing distance from the margins (30, 31) of the composite film (1). Also a method for producing a composite film (1) of this kind, to the use thereof, and also a solid-state electrochemical cell comprising a composite film (1) of this kind.

### BACKGROUND OF THE INVENTION

The invention relates to a composite film in which the constituents are distributed unevenly, thereby allowing the film to be used with particular advantage in the form of an electrode film or a separator film in a solid-state electrochemical cell. The invention also relates to a method for producing a composite film of this kind.

Modern electrochemical cells, especially for lithium-ion battery cells, are increasingly embodied as solid-state cells, meaning that they use solid electrolytes rather than liquid electrolytes. Such solid-state cells frequently comprise inorganic solid electrolytes. The latter are used typically in the form of composite films, using binders. The compression methods needed to produce pore-free composite films lead frequently to cracks in the composite films, especially at the margins of the composite films.

JP 2015-103433 discloses a solid electrolyte layer for a wound electrochemical cell, wherein the binder concentration in the solid electrolyte is higher at one end of the solid electrolyte layer along the winding direction than at the other end of the solid electrolyte layer along the winding direction.

### SUMMARY OF THE INVENTION

The invention provides a composite film consisting of a composition comprising at least one solid electrolyte and at least one binder, wherein the fraction of the at least one binder in the composition rises with decreasing distance from the margins of the composite film. The fraction may be described in weight percent based on the total weight of the composition.

The composite film consists of a composition which comprises at least one solid electrolyte and at least one binder, and wherein the at least one solid electrolyte and the at least one binder are not distributed evenly over the entire volume of the composite film. In accordance with the invention there is, within the composite film, an uneven distribution of the at least one solid electrolyte and of the at least one binder, thus producing at least one region which comprises a fraction higher on average of the at least one binder than in the rest of the regions of the composite film. A region of this kind, also referred to herein as binder-rich region, is preferably in the marginal regions of the composite film. The composite film here may have a gradient composition, wherein the fraction of the at least one binder in the composition rises gradually with decreasing distance from the margins of the composite film. Alternatively there may be a stepwise rise in the fraction of the at least one binder in the composition with decreasing distance from the margins of the composite film.

The composition of the composite film comprises at least one solid electrolyte. This solid electrolyte is preferably at least one inorganic solid electrolyte, more particularly selected from a sulfidic solid electrolyte and an oxidic solid electrolyte. Suitable inorganic solid electrolytes are known to the skilled person.

Suitable inorganic oxidic solid electrolytes are more particularly:

a) Garnets of the General Formula (I):

Li_{y}A₃B₂O₁₂ (I)
where A is selected from at least one element from the group of La, K, Mg, Ca, Sr and Ba,
B is selected from at least one element from the group of Zr, Hf, Nb, Ta, W, In, Sn, Sb, Bi and Te,
where 3≤y≤7.
Particularly preferred representatives are garnets of the formula (I) in predominantly cubic crystal structure, and more particularly lithium lanthanum zirconates (LLZO) of the formula Li₇La₃Zr₂O₁₂ and lithium lanthanum tantalates (LLTO) of the formula Li₅La₃Ta₂O₁₂.

b) Perovskites of the General Formula (II):

Li₃ₓLa_{2/3-x}TiO₃(LLTO) (II)

where 2/3≥x≥0.
Particularly preferred representatives are perovskites of Li_{0.35}La_{0.55}TiO₃.

c) Glasses and/or Glass-Ceramics of the NASICON Type, Represented by the General Formula (III):

Li₁₊ₓRₓM₂₋ₓ(PO₄)₃ (III)
where M is selected from at least one element from the group of Ti, Ge and Hf,
R is selected from at least one element from the group of Al, B, Sn and Ge, and where 0≤x<2.
Preferred representatives are lithium aluminum titanium phosphates (LATP, especially Li_{1.4}Al_{0.4}Ti_{1.6}(PO₄)₃), and lithium aluminum germanium phosphates (LAGP, especially Li_{1.5}Al_{0.5}Ge_{1.5}(PO₄)₃).

Suitable inorganic sulfidic solid electrolytes are more particularly:

a) Sulfidic Glasses and/or Glass-Ceramics of the General Formula (IV):

(1−a)[x(Li₂S)y(P₂S₅)z(MₙSₘ)]·a[LiX] (IV)
where MₙSₘ has the meaning of SnS₂, GeS₂, B₂S₃ or SiS₂,
X has the meaning of Cl, Br or I,
x, y and z each independently of one another may occupy a value of 0 to 1, with the proviso that x+y+z=1, and
a has a value of 0 to 0.5, more particularly 0 to 0.35.

Preferred representatives are Li₁₀GeP₂S₁₂, Li_{9.6}P₃S₁₂ and Li_{9.54}Si_{1.74}P_{1.44}Si_{11.7}Cl_{0.3}.

b) Sulfidic Glasses and/or Glass-Ceramics of the Formula (V):

Li₃PS₄ (V).

c) Sulfidic Glasses and/or Glass-Ceramics of the Formula (VI):

x[Li₂S]·(1−x)[P₂S₅] (VI)
where 0<x<1.

Preferred representatives are 0.67 [Li₂S]·0.33 [P₂S₅], 0.7 [Li₂S]·0.3 [P₂S₅] and 0.75 [Li₂S]·0.25 [P₂S₅].

d) Sulfidic Glasses and/or Glass-Ceramics of the Formula (VI):

(1−y)(0.7·Li₂S·0.3·P₂S₅)·yLiX (VI)
where X may have the meaning of F, Cl, Br and/or I, and
0≤y≤0.2; and
   preferred representatives are 0.9 (0.7·Li₂S·0.3·P₂S₅)·0.1 LiI and 0.9 (0.7·Li₂S·0.3·P₂S₅)·0.1 LiCl.

e) Argyrodites of the Formula (VII):

Li_{y}PS₅X (VII)
where y has a value of 7 and X has the meaning of S, or
where y has a value of 6 and X may be selected from Cl, Br and I, and mixtures thereof.

Preferred representatives are Li₇PS₆, Li₆PS₅Cl and Li₆PS₅I.

The composition of the composite film further comprises at least one binder. Suitable binders comprise at least one organic polymer. It is possible here to use all binders which are typically employed in solid electrolyte composites. Suitable binders are known to the skilled person and comprise binders which serve exclusively to improve the stability of the composite film (and are also herein called polymer binders) and binders which take on other functions as well. Falling within the latter group are in particular, among others, polymer electrolytes and polyelectrolytes. Besides the at least one polymer, therefore, the binder may also comprise further constituents, especially conductive salts for improving the ion conductivity.

Suitable polymer binders include, in particular, carboxymethylcellulose (CMC), styrene-butadiene copolymer (SBR), polyvinylidene fluoride (PVDF), polytetrafluoroethylene (PTFE), polyacrylonitrile (PAN) and ethylene-propylene-diene terpolymer (EPDM).

Polymer electrolytes comprise at least one polymer and at least one conductive salt, more particularly a lithium salt.

Deserving of emphasis as suitable polymers for the stated polymer electrolytes are, in particular, polyalkylene oxide derivatives of polyethylene oxide, polypropylene oxide and the like, or polymers comprising polyalkylene oxide derivatives; derivatives of polyvinylidene fluoride (PVDF), polyhexafluoropropylene, polycarbonates, polyacrylates, polyphosphoric acid esters, polyalkylimines, polyacrylonitrile, poly(meth)acrylic acid esters, polyphosphazenes, polyurethanes, polyamides, polyesters, polysiloxanes, polymalonic acid esters and the like. Derivatives deserving of particular emphasis are fluorinated or partly fluorinated derivatives of the aforesaid polymers. Likewise suitable are block copolymers and brush copolymers of various representatives of the aforesaid polymer classes. These copolymers may also comprise mechanically robust polymer blocks, such as polystyrene or polyimides, for example. Likewise encompassed are crosslinked polymers and oligomers (i.e., for the purposes of this invention, polymers having >2 and <20 repeat units of the monomers) of which the polymer is constructed. Polymers having ≥20 repeat units are referred to herein as polymer. Preferred polymer compounds are those which have an oxyalkylene structure, a urethane structure or a carbonate structure in the molecule. For example, preference is given to polyalkylene oxides, polyurethanes and polycarbonates in relation to their good electrochemical stability. Preference is given, further, to polymers having a fluorocarbon group. Polyvinylidene fluoride and polyhexafluoropropylene are preferred in relation to their stability. The number of repeat units of these oxyalkylene, urethane, carbonate and/or fluorocarbon units is preferably in a range from in each case 1 to 1000, more preferably in a range from 5 to 100. Especially preferred are polyalkylene oxides such as polyethylene oxide, polypropylene oxide with 1 to 1000, more preferably 5 to 100, repeat units.

To improve the ion conductivity, the at least one polymer in the polymer electrolyte is typically admixed with at least one conductive salt. Suitable conductive salts are, in particular, lithium salts. The conductive salt may for example be selected from the group consisting of lithium halides (LiCl, LiBr, LiI, LiF), lithium perchlorate (LiClO₄), lithium tetrafluoroborate (LiBF₄), lithium hexafluorophosphate (LiPF₆), lithium hexafluoroarsenate (LiAsF₆), lithium nitrate (LiNO₃), lithium trifluoromethanesulfonate (LiSO₃CF₃), lithium bis(fluorosulfonyl)imide (Li[N(SO₂F)₂], LiFSI), lithium bis(trifluoromethylsulfonyl)imide (Li[N(SO₂(CF₃))₂], LiTFSI), lithium bis(pentafluoroethylsulfonyl)imide (LiN(S₂C₂F₅)₂, LiBETI), lithium bis(oxalato)borate (LiB(C₂O₄)₂, LiBOB), lithium difluoro(oxalato)borate (Li[BF₂(C₂O₄)], LiDFOB), lithium difluorotri(pentafluoroethyl) phosphate (LiPF₂(C₂F₅)₃) and combinations thereof. With particular preference the conductive salt is selected from lithium iodide (LiI), lithium perchlorate (LiClO₄), lithium tetrafluoroborate (LiBF₄), lithium hexafluorophosphate (LiPF₆), lithium bis(fluorosulfonyl)imide (Li[N(SO₂F)₂], LiFSI) and lithium bis(trifluoromethylsulfonyl)imide (Li[N(SO₂(CF₃))₂], LiTFSI), and combinations thereof. The conductive salts may each be used individually or in combination with one another.

The at least one conductive salt preferably accounts for a fraction of 1 to 50 wt %, more particularly 2 to 40 wt %, of the total weight of the polymer electrolyte. A polyelectrolyte for the purposes of this invention is a polymer which comprises a polymer backbone and a multiplicity of anionic functional groups which are bonded covalently to said backbone and having as counterion an alkali metal cation, more particularly a lithium ion. The anionic functional groups bonded covalently to the polymer backbone are selected, for example, from sulfonate groups (—SO₃⁻), sulfonylimide groups (—(SO₂)—N⁻—(SO₂)—), tetraalkylborate groups (B.R₄, such as B.(C₂O₄)₂—), for example, and mixtures thereof. The polymer backbone is formed, for example, of polysulfones, polyetherketones, polyimides, polystyrene, and also copolymers and mixtures thereof. Moreover, the polyelectrolyte may be admixed with one or more conductive salts, which are preferably selected from the lithium salts stated above.

The composition of the composite film may optionally also comprise further constituents.

In one embodiment of the invention, the composite film comprises no constituents other than the above-stated solid electrolytes and binders. In this embodiment, the composite film is conductive with respect to ions, especially lithium ions, and substantially nonconductive electrically. A composite film of this kind may be used advantageously as a separator in a solid-state electrochemical cell, and is also referred to herein as separator film.

In an alternative embodiment of the invention, the composite film, besides the above-stated solid electrolytes and binders, comprises at least one electrode active material as a further constituent. The composition of the composite film of this embodiment preferably further comprises at least one electrical conductivity additive. A composite film of this kind is conductive with respect to ions, especially lithium ions, and conductive electrically. A composite film of this kind may be used advantageously as an electrode in a solid-state electrochemical cell, and is also referred to herein as electrode film.

Suitable electrical conductivity additives are conductive carbon black, graphite, and carbon nanotubes.

In principle the electrode film may comprise cathode active materials or anode active materials. Suitable materials are known fundamentally to the skilled person.

Deserving of emphasis as suitable cathode active materials are layered oxides such as lithium nickel cobalt aluminum oxides (NCA; e.g., LiNi_{0.5}Co_{0.15}Al_{0.05}O₂), lithium nickel cobalt manganese oxides (NCM; e.g., LiNi_{0.8}Mn_{0.1}Co_{0.1}O₂(NMC (811)), LiNi_{0.33}Mn_{0.33}Co_{0.33}O₂(NMC (111)), LiNi_{0.6}Mn_{0.2}Co_{0.2}O₂ (NMC (622)), LiNi_{0.5}Mn_{0.3}Co_{0.2}O₂ (NMC (532)) or LiNi_{0.4}Mn_{0.3}Co_{0.3}O₂ (NMC (433)), overlithiated layered oxides of the general formula n(Li₂MnO₃)·1-n (LiMO₂) with M=Co, Ni, Mn, Cr and 0≤n≤1, spinels of the general formula n(Li₂MnO₃)·1-n (LiM₂O₄) with M=Co, Ni, Mn, Cr and 0≤n≤1. Additionally there are, in particular, spinel compounds of the formula LiMₓMn₂₋ₓO₄ with M=Ni, Co, Cu, Cr, Fe (e.g., LiMn₂O₄, LiNi_{0.5}Mn_{1.5}O₄), olivine compounds of the formula LiMPO₄ with M=Mn, Ni, Co, Cu, Cr, Fe (e.g., LiFePO₄, LiMnPO₄, LiCoPO₄), silicate compounds of the formula Li₂MSiO₄ with M=Ni, Co, Cu, Cr, Fe, Mn (e.g., Li₂FeSiO₄), tavorite compounds (e.g., LiVPO₄F), Li₂MnO₃, Li_{1.17}Ni_{0.17}Co_{0.1}Mn_{0.56}O₂, LiNiO₂, Li₂MO₂F (with M=V, Cr), Li₃V₂(PO₄)₃, conversion materials such as FeF₃, V₂O₅ and/or sulfur-containing materials such as sulfur-polyacrylonitrile composites (SPAN).

Deserving of emphasis as suitable anode active materials are carbon derivatives such as graphite and amorphous carbon, silicon derivatives, such as nanocrystalline, amorphous silicon, and lithium titanate (Li₄Ti₅O₁₂).

In one particularly preferred embodiment, the electrode film comprises at least one cathode active material and also preferably at least one electrical conductivity additive. The composite film of this embodiment of the invention is therefore a cathode film.

The composite film of the invention has a certain height (also called film thickness), a certain width (also called film width) and a certain length (also called film length). Height, length and width here are orthogonal to one another in the three-dimensional space, and the height (film thickness) denotes the spatial direction in which the composite film has the shortest lengthwise extent. The length (film length) denotes the spatial direction in which the composite film has the longest lengthwise extent. The width (film width) denotes the extent of the composite film in the spatial direction which lies orthogonal to the above-defined height and length. Typically at least two of the lengthwise extents are different from one another. Typically the film thickness is less than the film width and/or the film length. The film width and film length may be the same in one embodiment of the invention.

The composite film of the invention has in each case two margins along the film length and—except for continuous films—in each case two margins along the film width. The composite film is bounded by these margins. Reference herein to a marginal region is to a region of the composite film (or of the volume of the composite film) which extends orthogonally to the respective margin into the composite film and makes up in each case at least 10%, preferably at least 15%, of the overall film width or film length, respectively. In the extent direction of the film thickness (height), reference is made, in the context of this invention, not to margins but instead—where necessary—to surfaces.

The composite film of the invention is notable preferably in that the composite film in at least one marginal region has a composition whose average fraction of binder is at least 10 wt %, preferably at least 15 wt %, higher than the average fraction of binder in the rest of the composition of which the composite film is formed. This relates preferably at least to two marginal regions, which extend along the film length and/or the film width.

The composite film of the invention preferably has a film thickness of 0.1 to 1000 μm, more preferably 1 to 500 μm, more particularly 2 to 100 μm.

The composite film of the invention typically has a film width of 1 to 1000 mm, preferably 5 to 500 mm, more particularly 10 to 100 mm.

The composite film of the invention typically has a film length of at least 10 mm, preferably at least 50 mm, more particularly at least 75 mm. In one embodiment the film length is not more than 1000 mm, preferably not more than 500 mm, more particularly not more than 200 mm. In an alternative embodiment the composite film is fabricated as continuous film. In this embodiment, the composite film has an infinite film length. Although in this embodiment the composite film can be cut for later use, a continuous film for the purposes of this invention has only two marginal regions, these being along the film length of the composite film.

The invention also provides a method for producing the composite film of the invention. In principle, any method for production is suitable that is known to the skilled person and is suitable for the production of a composite film having the features described. It is possible, for example, for the constituents of the composition of the composite film to be first provided separately in different mixing ratios and for these to then be supplied to a film formation process in such a way as to obtain a composite film which has a central region, which is the furthest distant from the margins of the composite film that bound said film in the extent direction of the film width, and has a composition which has the lowest fraction of binder. The region with the highest fraction of binders is to be found in the marginal regions of the composite film, more particularly in the marginal regions of the composite film that extend along the film length. The marginal regions of the composite film that extend along the film width preferably also have a composition with an averagely higher fraction of binders. In this way it is possible in particular to produce a composite film in which the fraction of the at least one binder in the composition rises stepwise with decreasing distance from the margins of the composite film.

The inventors of the present invention have found that a composite film in which the fraction of the at least one binder in the composition rises gradually with decreasing distance from the margins of the composite film can be produced by means of a particularly simple method which can easily be integrated into existing fabrication processes. This method is likewise provided by the present patent application, and comprises at least one method step in which at least one region of the composite film that is to have a higher fraction of binder after the implementation of the method is heated to a minimum temperature T2 which lies above the maximum temperature T1 to which the rest of the regions of the composite film are heated.

To implement the method of the invention, a composition is first provided which comprises at least one solid electrolyte and at least one binder. A composite film is formed from this composition in a conventional way. This may be done by at least partly plastifying the composition, by supply of energy, and then processing it by extrusion, rolling and/or calendering processes to give a film with an even composition. Alternatively, it is also possible to use a solvent which is capable of at least partly dissolving the at least one binder, so as to obtain a moldable compound (slurry), which can be shaped into a layer and, by removal of the solvent, converted into an even composite film. Suitable solvents are known to the skilled person and comprise, in particular, methylpyrrolidone (NMP), cyclohexanone or water. The step of forming a layer may be accomplished—depending on the amount of solvent and on the consistency of the moldable compound—by coating processes such as doctor blade coating, spin coating, dip coating or spray coating, or else by means of the aforesaid extrusion, rolling and/or calendering processes.

A combination of both processes—that is, the addition of solvent and energy—is also conceivable for plastifying the composition.

The even composite film obtained is subsequently subjected to a method step wherein exposure of different regions of the even composite film to different temperatures leads to at least partial softening of the composite film and to migration of the constituents within the composite film. This is achieved by heating the whole film to a maximum temperature T1, while the regions of the composite film which after the end of the method are to have an averagely higher fraction of binders than the rest of the regions of the composite film are heated to a minimum temperature T2, the temperature T2 lying above the temperature T1. As a result of this temperature difference, the constituents of the composition migrate within the even composite film, and so, after implementation of the method of the invention, a composite film with uneven distribution of the constituents is obtained.

In one preferred embodiment of the invention, the temperatures T1 and T2 lie above the glass transition temperature and/or the melting temperature of the binder used, more particularly above the melting temperature. Where a mixture of two or more binders is used, the critical temperature for this is the respective temperature of the binder having the highest glass transition temperature and/or the melting temperature. The temperature T2 is preferably at least 10° C. higher than the temperature T1, more preferably at least 25° C. higher, and more particularly at least 50° C. higher. The temperature T2 is preferably below the decomposition temperature of the at least one binder, more particularly at least 10° C. below the decomposition temperature of the at least one binder. Where a mixture of two or more binders is used, the critical binder for this is the binder having the lowest decomposition temperature.

The temperature treatment described herein, according to the method of the invention, is carried out preferably over a period of 1 second to 10 hours, more preferably over a period of 10 seconds to 1 hour, and more particularly over a period of 1 minute to 30 minutes.

The temperature treatment according to the method of the invention is preferably carried out in such a way that exclusively the marginal regions of the composite electrode are heated at least to the temperature T2, with the central regions of the composite film being heated at most to the temperature T1. For this purpose it may be necessary, where appropriate, for the central regions to be cooled, so that the temperature T1 is not exceeded there.

After the end of the temperature treatment according to the method of the invention, the uneven composite film can be cooled and used subsequently for producing solid-state electrochemical cells. The composite film may optionally be compacted by means of a rolling or compression process, in order to increase the contacting of the solid electrolyte particles. Here, the marginal regions have a low tendency to develop cracks, owing to the increased binder fraction.

The invention also provides for the use of a composite film of the invention, or of a composite film obtained according to the method of the invention, as separator film and/or as electrode film in a solid-state electrochemical cell. For use as a separator film, the composite film preferably comprises exclusively at least one solid electrolyte and also at least one binder, and optionally at least one conductive salt. For use as an electrode film, the composite film preferably comprises at least one solid electrolyte, at least one binder, and also at least one active material, and optionally at least one conductive salt and/or at least one electrical conductivity additive. In one preferred use, the composite film comprises at least one cathode active material and is used as a cathode film in the positive electrode of a solid-state electrochemical cell.

The invention also provides a solid-state electrochemical cell comprising at least one composite film of the invention. This composite film may be used, as described above, as separator film and/or electrode film. The composite film is preferably used as separator film and/or as cathode film.

In one preferred embodiment, the invention relates to a solid-state electrochemical cell comprising at least one positive electrode (cathode), at least one negative electrode (anode), and at least one separator, where the positive electrode comprises a cathode film of the invention and/or the separator comprises a separator film of the invention, and where the negative electrode comprises an active material film whose spatial extent is the same as or smaller than the spatial extent of the cathode film of the invention and/or of the separator film of the invention. With particular preference the spatial extent of the active material film is less than or equal to the spatial extent of the cathode film of the invention and/or of the separator film of the invention. The positive electrode and the negative electrode further comprise at least one electrically conductive current collector, which is preferably fabricated from a metal and more particularly comprises at least one element selected from Cu, Al, Ni and optionally (in the case of the negative electrode) Li.

The active material film of the negative electrode here comprises at least one active material and optionally at least one binder, at least one electrical conductivity additive and optionally at least one conductive salt. Where the active material film of the negative electrode comprises at least one binder, the anode active material film is preferably not a composite film of the invention, but is instead an anode active material film having an even composition. In one embodiment the anode active material film is a lithium metal foil.

A feature of the composite film of the invention is that this film in the marginal regions has an averagely higher fraction of binders than in the rest of the regions of the composite film. As a result of the greater flexibility of the binders, the marginal regions are therefore less susceptible to formation of cracks during the processing of the composite film.

The method of the invention allows the composite film of the invention to be produced with the aid of a temperature treatment step which can be integrated simply into existing production processes.

Through the use of the composite film of the invention as separator film or electrode film, more particularly as cathode film, it is possible to provide a solid-state electrochemical cell having improved properties. Cathode films with an even distribution of the constituents customarily lead to overvoltages in the marginal regions of solid-state electrochemical cells when these cathode films have the same size as the anode films used or are larger than them. In conventional solid-state electrochemical cells, therefore, it is usual to use anode films which are larger than the cathode films. With the use of the composite film of the invention as cathode film and/or solid electrolyte film, this measure is no longer necessary. It is therefore possible to make savings in the material of the anode, and to increase the energy density and power density of the solid-state electrochemical cell.

### BRIEF DESCRIPTION OF THE DRAWINGS

Exemplary embodiments of the invention are elucidated in more detail using drawings and the description hereinafter:

FIG. 1 shows the schematic representation of a composite film of the invention; and

FIG. 2 shows the schematic representation of a method for producing a composite film of the invention.

### DETAILED DESCRIPTION

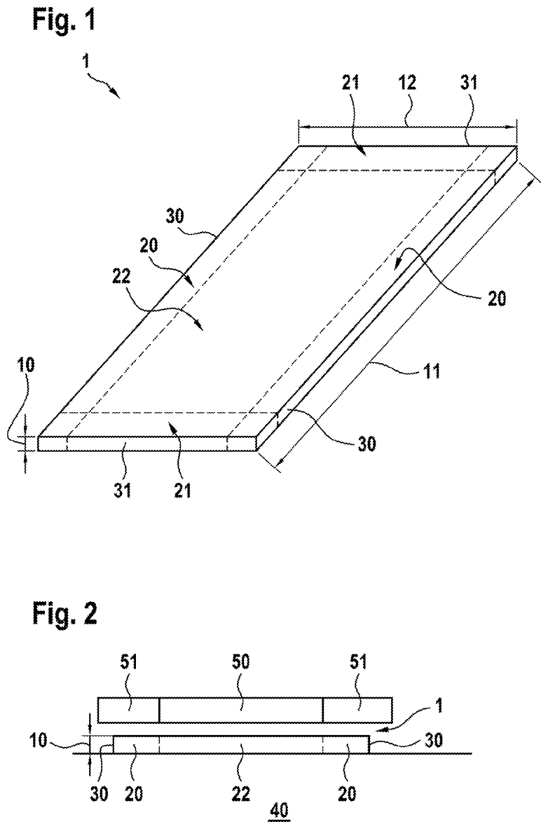

Represented schematically in FIG. 1 is a composite film 1 of the invention. This film has a film thickness 10, a film length 11 and a film width 12, which represent spatial directions orthogonal to one another. The film thickness 10 here has the shortest extent, the film length 11 the longest extent. The extent of the film width 12 lies between the film thickness 10 and the film length 11 and may be equal to one of the two. The film width 12 is bounded by the margins 30. The film length 11 is bounded by the margins 31. The composite film 1 has a central region 22 which is surrounded by marginal regions 20, 21. The marginal region 20 extends along the lengthwise extent of the composite film 1 over the entire film length 11. The marginal region 21 extends along the transverse extent of the composite film 1 over the entire film width 12. The central region 22 and the marginal regions 20, 21 consist of a composition which comprises at least one solid electrolyte and at least one binder. The composition may further comprise active materials, electrical conductivity additives and/or conductive salts for improving the ion conductivity. The marginal regions 20, 21 each occupy at least 10% of the film width 12 or film length 11, respectively, and are notable in that they have a composition whose fraction of binder is averagely higher than the average fraction of binder in the central region 22. The composite film 1 therefore has an uneven distribution of the constituents of the composition of which the composite film 1 is formed. This uneven distribution may take the form of a gradient or of a stepwise change.

FIG. 2 shows schematically a method for producing a composite film 1 having a gradual distribution in composition of the binder in the marginal regions 20 and the central region 22. For this purpose, a composite electrode 1 having an even distribution of the constituents is first produced by a conventional method. This composite electrode 1, more particularly the central region 22, is subsequently heated, in the temperature treatment step of the method of the invention, to a maximum temperature T1 which lies above the melting temperature of the at least one binder of the composite electrode 1. This maximum temperature T1 is established by means of a temperature control apparatus 50. The marginal regions 20 of the composite electrode 1 in which a higher binder fraction is to be obtained are heated, moreover, to a minimum temperature T2 which lies above the temperature T1. This temperature T2 is established by means of additional temperature control apparatuses 51. The temperature treatment step essential to the invention may be carried out, for example, such that a continuous film of the even composite film is guided through on a substrate 40, under a corresponding arrangement of the temperature control apparatuses 50, 51, in such a way that the composite film 1 has a residence time of 2 minutes, for example, within the range temperature-controllable by the temperature control apparatuses 50, 51. During this time, the binder softens and migrates into those regions of the composite film 1 that are exposed to the higher temperature T2. After the end of the temperature step, the composite film 1 solidifies, and comprises the uneven distribution according to the invention, with the marginal regions 20 and the central region 22.

The invention is not confined to the exemplary embodiments described herein and to the aspects emphasized therein. Instead, within the range specified by the claims, there are a multitude of possible modifications which are within the scope of practice of a skilled person.

1. A composite film (1) comprising a composition including at least one solid electrolyte and at least one binder, the fraction of binder in the composition rising with decreasing distance from margins (30, 31) of the composite film (1).

2. The composite film (1) according to claim 1, wherein the composite film (1) is in the form of a separator film or an electrode film.

3. The composite film (1) according to claim 1, wherein the composition further includes a cathode active material and the composite film (1) is in the form of an electrode film.

4. The composite film (1) according to claim 1, wherein the composite film (1) in at least one marginal region (20, 21) has a composition with an average fraction of binder that is at least 10 wt % higher than the average fraction of binder in the rest of the composition of which the composite film (1) is formed.

5. The composite film (1) according to claim 2, wherein the composition further includes a cathode active material and the composite film (1) is in the form of an electrode film.

6. The composite film (1) according to claim 5, wherein the composite film (1) in at least one marginal region (20, 21) has a composition with an average fraction of binder that is at least 10 wt % higher than the average fraction of binder in the rest of the composition of which the composite film (1) is formed.

7. A solid-state electrochemical cell comprising at least one composite film (1) according to claim 1.

8. The solid-state electrochemical cell according to claim 7, wherein the at least one composite film (1) is at least one cathode film and/or at least one separator film, and wherein the solid-state electrochemical cell further comprises at least one anode film which is smaller than or the same size as the at least one cathode film and/or at least one separator film.

9. A method for producing a composite film (1) according to claim 1, wherein the method comprises at least one method step in which at least one region of the composite film (1) that is to have a higher fraction of binder after implementation of the method is heated to a minimum temperature T2 which lies above the maximum temperature T1 to which the rest of the regions of the composite film (1) are heated.

10. The method according to claim 9, wherein the temperatures T1 and T2 lie above the glass transition temperature and/or the melting temperature of the binder used.

11. The method according to claim 9, wherein the minimum temperature T2 lies at least 20° C. above the maximum temperature T1.
